(19) United States
(12) Patent Application Publication
(10) Pub. No.: US 2026/0135828 A1
(43) Pub. Date: May 14, 2026

(54) METHOD AND DEVICE FOR PROVIDING INSTANT MESSAGING SERVICE

(71) Applicant: KAKAO CORP., Jeju-si (KR)

(72) Inventors: HAE YOON CHO, Seongnam-si (KR); WONJI KIM, Seongnam-si (KR); SOO YEUN JANG, Seongnam-si (KR); JISUN JUN, Seongnam-si (KR); EUNJU OH, Seongnam-si (KR); SANG KYUN AHN, Seongnam-si (KR); YUNHWAN KIM, Seongnam-si (KR); YOOJIN LEE, Seongnam-si (KR); HEE KYUNG CHO, Seongnam-si (KR); UN BONG KANG, Seongnam-si (KR); HYUNJI LEE, Seongnam-si (KR); SUYEON SONG, Seongnam-si (KR); YUNEUI CHOI, Seongnam-si (KR); MYOUNG GUN HAN, Seongnam-si (KR); MARIA PARK, Seongnam-si (KR); HYE RYEON LEE, Seongnam-si (KR); SUMIN CHO, Seongnam-si (KR); MIN WOO RYU, Seongnam-si (KR); SEUNGHYUNG LEE, Seongnam-si (KR); HEEYOUNG OH, Seongnam-si (KR); HYEJIN KANG, Seongnam-si (KR)

(73) Assignee: KAKAO CORP., Jeju-si (KR)

(21) Appl. No.: 19/386,558

(22) Filed: Nov. 12, 2025

(30) Foreign Application Priority Data
Nov. 13, 2024 (KR) 10-2024-0161460
Feb. 11, 2025 (KR) 10-2025-0017497

(51) Int. Cl. H04L 51/046; G06F 16/334

(52) U.S. Cl. CPC H04L 51/046; G06F 16/3344

(57) ABSTRACT

A user terminal includes a display, at least one processor having processing circuitry, and a memory storing instructions. When executed, the instructions cause the user terminal to display a first chat room screen corresponding to a first chat room in which the user account and another user account participate. On the first chat room screen, the terminal obtains a query message input through a second chat room established between the user account and a virtual object assigned to the user account. Based on a response message generated using at least one message transmitted through the first chat room, the terminal displays the response message through the second chat room. The configuration allows the user to interact with the virtual object within the context of the first chat room, providing a private communication layer that utilizes prior chat data to generate contextually relevant responses.

### CROSS-REFERENCE TO RELATED APPLICATION

This application claims the benefit of Korean Patent Application No. 10-2024-0161460, filed on Nov. 13, 2024, and Korean Patent Application No. 10-2025-0017497, filed on Feb. 11, 2025, in the Korean Intellectual Property Office, the entire disclosure of which is incorporated herein by reference for all purposes.

### BACKGROUND

### Technical Field

The present disclosure relates to computer-implemented communication systems, and more particularly to systems and methods that improve the processing, retrieval, and contextual understanding of messages in network-based instant messaging services.

### Description of the Related Art

Recently, with the development of mobile smart devices, the use of an online platform service to communicate with other users via a network has increased. The online platform service for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users. As the interaction among users via mobile devices increases, the online platform services provide various service functions based on communication among users in addition to a chat service for conversations with other users.

Conventional instant messaging services primarily transmit and display user-generated text and media without structural awareness of the conversational context across multiple chat rooms. As a result, such systems are limited in their ability to retrieve, process, or summarize prior communications in real time. Furthermore, current chat systems lack the capability to concurrently manage independent virtual sessions within an active chat interface, resulting in inefficient resource utilization, increased latency, and fragmented user experiences. The embodiments described herein address these computer-implemented limitations by introducing a multi-layer chat processing framework and an intelligent memory architecture that optimize communication processing at both the server and terminal levels.

### BRIEF SUMMARY

The disclosed embodiments provide a technical solution to the limitations of existing messaging systems by introducing a dual-layer chat architecture and hierarchical memory framework that enable concurrent message processing and context-based response generation with reduced resource consumption and latency.

In particular, the disclosure relates to an intelligent instant messaging system that integrates a dual layer chat interface and an artificial intelligence based virtual assistant. Within a regular chat room, a user can invoke a private overlay chat with a virtual character that communicates independently and contextually without leaving the main conversation. This layered chat mechanism enables smooth transitions between public and private interactions while maintaining continuity of context and user experience.

The system employs a context aware response generation engine supported by structured memory. Messages are analyzed and grouped into topic based threads and message chunks that form short term memory, while user level data such as preferences, relationships, and communication style constitute long term memory. Using machine learning models for topic and action extraction, the system generates responses based on relevant message histories across multiple chat rooms, allowing the virtual character to provide personalized and contextually coherent interactions.

The platform further enhances social connectivity and personalization by recommending chat participants based on proximity, motion similarity, or semantic relationships identified from chat content. Users may also exchange content through their virtual characters, enabling a mediated and emotionally engaging communication channel. The disclosure therefore provides a messaging environment that combines artificial intelligence driven conversation, hierarchical memory management, and personalized virtual character interaction within a single integrated service.

According to an embodiment, a method performed by a server that provides an instant messaging service (IMS), includes transmitting, to a user terminal using the IMS with a user account, information to display a first chat room screen corresponding to a first chat room in which the user account and another user account join, based on receiving a query message input via a second chat room between the user account and a virtual object assigned to the user account, generating a response message based on at least one message transmitted via the first chat room, and transmitting the response message via the second chat room.

The method includes transmitting, to the user terminal, information for the user terminal to generate a layer to display an overlay on the first chat room screen and render a screen corresponding to the second chat room on the layer.

Information about a message transmitted via the second chat room including the second query message and the second response message is not provided to the other user account.

The generating of the response message includes generating the response message based on at least one message transmitted via the first chat room and at least one message transmitted via a third chat room in which the user account joins, and the third chat room is independent of the first chat room.

The generating of the response message includes, based on that a number of target message chunks associated with the query message among message chunks transmitted via the first chat room is less than a threshold number, generating the response message based on at least one message chunk transmitted via the third chat room.

The generating of the response message includes, based on that a number of target message chunks associated with the query message among message chunks transmitted via the first chat room is greater than or equal to a threshold number, excluding a message chunk transmitted via the third chat room from generating the response message.

The generating of the response message includes determining a target message chunk associated with the query message among message chunks transmitted via the first chat room, based on that the query message requests to search for a message transmitted via at least one chat room, generating the response message based on messages included in the target message chunk, and based on that the query message does not request to search for the message transmitted via the at least one chat room, generating the response message based on a summary of the target message chunk.

The query message includes a second query message, the response message includes a second response message, and the method further includes transmitting a first query message input on the first chat room screen to the server, transmitting information to display the first query message to another user terminal using the IMS with the other user account, generating a first response message to the first query message, and transmitting, to the user terminal and the other user terminal, the first response message via the first chat room.

The generating of the first response message includes excluding a message transmitted via a chat room other than the first chat room from generating the first response message.

The method further includes receiving a recommendation request to recommend an account to be invited to a chat room from the user terminal, among friend accounts registered as friends in the user account, determining at least one of an account that uses a terminal positioned near the user terminal, an account that uses a terminal obtaining a motion input that is the same as or similar to a motion input obtained from the user terminal, or an account determined from the friend accounts based on text describing the chat room, to be a recommended account, and transmitting, to the user terminal, information to display information about the determined recommended account.

The method includes receiving user information from the user terminal, generating a profile of a virtual character of the user account based on the user information, transmitting information to display information about the profile of the virtual character to the user terminal, and transmitting information to display the second chat room as a chat room in which the user account and the virtual character join.

The method further includes receiving, from the other user terminal using the IMS with the other user account, a content transmission request to transmit content to the user account from the other user account via the virtual character, and transmitting, to the user terminal, information to output the content corresponding to the content transmission request via the virtual character in a profile of the user account.

The generating of the response message includes transmitting information to display a screen corresponding to the second chat room to the user terminal based on a user input to invoke the second chat room, and the user input is obtained from the first chat room screen.

According to an embodiment, a method performed by a user terminal using an IMS with a user account, includes displaying a first chat room screen corresponding to a first chat room in which the user account and another user account join, on a first chat room screen, displaying a screen corresponding to a second chat room between the user account and a virtual object assigned to the user account, obtaining a query message input via the second chat room, and based on obtaining a response message generated based on at least one message transmitted via the first chat room, displaying the response message via the second chat room.

The displaying of the screen corresponding to the second chat room includes generating a layer to display an overlay on the first chat room screen, and rendering the screen corresponding to the second chat room on the generated layer.

A message transmitted via the second chat room including the query message and the response message is not provided to the other user account.

The response message is generated based on at least one message transmitted via the first chat room and at least one message transmitted via a third chat room in which the user account joins, and the third chat room is independent of the first chat room.

The response message is generated based on at least one message chunk transmitted via the third chat room based on that a number of target message chunks associated with the query message among message chunks transmitted via the first chat room is less than a threshold number.

Based on that a number of target message chunks associated with the query message among message chunks transmitted via the first chat room is greater than or equal to a threshold number, a message chunk transmitted via the third chat room in which the user account joins is excluded from generating the response message.

Based on that a search for a message transmitted via at least one chat room in the query message is requested, the response message is generated based on messages included in the target message chunk associated with the query message among the message chunks transmitted via the first chat room, and based on that the search for the message transmitted via at least one chat room in the query message is not requested, the response message is generated based on a summary of the target message chunk.

The query message includes a second query message, the response message includes a second response message, and the method further includes obtaining a first query message input via the first chat room, and based on obtaining a first response message to the first query message, displaying the first response message on the first chat room screen, and the first query message and the first response message are provided to the other user account.

A message transmitted via another chat room other than the first chat room is excluded from generating the first response message.

The method further includes transmitting, to the server, a recommendation request to recommend an account to be invited to a chat room, and based on information received from the server, displaying information about at least one of an account that uses a terminal positioned near the user terminal among friend accounts registered as friends in the user account, an account that uses a terminal obtaining a motion input that is the same as or similar to a motion input obtained from the user terminal, or an account determined from the friend accounts based on text describing the chat room, as information about a recommended account.

The method obtaining the user information, and displaying information about a profile of a virtual character of the user account based on the user information, and the displaying of the screen corresponding to the second chat room includes displaying the second chat room as a chat room in which the user account and the virtual character join.

The method includes, based on a content transmission request to transmit content to the user account from the other user account via the virtual character, outputting the content via the virtual character from the profile of the user account.

The displaying of the screen corresponding to the second chat room includes, based on obtaining a user input to invoke the second chat room in the first chat room screen, displaying the screen corresponding to the second chat room.

According to an embodiment, a server includes at least one processor including processing circuitry, and a memory storing instructions, wherein the instructions, when executed by the at least one processor, cause the server to transmit, to a user terminal using an IMS with a user account, information to display a first chat room screen corresponding to a first chat room in which the user account and another user account join, based on receiving a query message input via a second chat room between the user account and a virtual object assigned to the user account, generate a response message based on at least one message transmitted via the first chat room, and transmit the response message via the second chat room.

According to an embodiment, a user terminal includes a display, at least one processor including processing circuitry, and a memory storing instructions, wherein the instructions, when executed by the at least one processor, cause the user terminal to display a first chat room screen corresponding to a first chat room in which the user account and another user account join, on the first chat room screen, display a screen corresponding to a second chat room between the user account and a virtual object assigned to the user account, and based on obtaining a response message generated based on at least one message transmitted via the first chat room, display the response message via the second chat room.

The disclosed embodiments provide a messaging architecture that enhances the operational efficiency and responsiveness of computer-based communication systems. Through coordinated management of multiple concurrent chat contexts, the system enables a user terminal to invoke a secondary, private chat session with a virtual object while maintaining the primary chat interface. The architecture further employs a structured data model in which messages are segmented, classified, and stored as hierarchical memory data—thereby allowing the system to generate contextually accurate response messages with reduced computational overhead and improved real-time performance. These processes represent improvements to the technical functioning of the messaging platform and to the efficiency of network-based data processing systems.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 illustrates an example of a messaging system according to an embodiment;

FIG. 2 illustrates an example of a screen provided via a messaging service according to an embodiment;

FIG. 3 illustrates an example of an operation of generating a profile of a virtual character according to an embodiment;

FIG. 4 is a flowchart of an example of a method of collecting chat data for each chat room by a server according to an embodiment;

FIG. 5 is a flowchart of an example of a method of collecting chat data for each user account by a server according to an embodiment;

FIG. 6 illustrates an example of an operation of collecting chat data by a server according to an embodiment;

FIG. 7 illustrates an example of an operation of a server to add a specific message to chat data collected with respect to a user account according to an embodiment;

FIGS. 8, 9, and 10 illustrate examples of a function to recommend an account to be invited to a chat room in a messaging service according to an embodiment;

FIG. 11 illustrates an example of a function to transmit content to another user account using a personal mate in a messaging service according to an embodiment;

FIG. 12 illustrates an example of a function to display information indicating interactions among virtual characters of user accounts according to an embodiment;

FIG. 13 illustrates an example of a function to invoke a personal mate chat room in a regular chat room according to an embodiment; and

FIG. 14 illustrates an example of a hardware configuration of a system for a messaging service according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

The embodiments disclosed herein achieve technical effects including reduced response latency, improved memory utilization, and enhanced contextual accuracy of generated messages, thereby improving the overall efficiency of the computer-implemented messaging service.

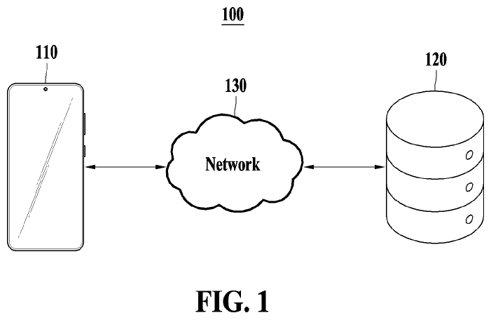

FIG. 1 illustrates an example of a messaging system according to an embodiment.

A messaging system 100 according to an embodiment may include a user terminal 110, a server 120, and a network 130.

The user terminal 110 may be one of electronic devices, such as a computer, a portable computer, a wireless phone, a mobile phone, a smartphone, a personal digital assistant (PDA), a web tablet, and a wearable device, and may refer to any device that may install or execute an application (hereinafter, also referred to as an “app”) associated with the server 120 or execute a web. In this case, the user terminal 110 may perform the overall operation of a service, such as configuring a service screen, inputting data, transmitting and receiving data, and storing data, under the control of the app or web. The user terminal 110 may process a user interface or user interaction via a processor and may output or transmit a processing result via an output device of the user terminal 110. In the embodiments of the present disclosure, the user terminal 110 may be briefly referred to as a “terminal”.

The user terminal 110 may execute an app or web associated with a service provided by the server 120. The user may use a service provided by the server 120 by executing the app or web associated with the service via the user terminal 110.

The server 120 may include a server that provides an instant messaging service (IMS) via the network 130 and/or a social networking service.

The server 120 may provide a messaging service (e.g., an IMS) to the user terminal 110. According to an embodiment, the messaging service may refer to a messenger service in which a user transmits and receives text, a picture, voice, and the like in real time via a network. The messaging service (e.g., the IMS) may be installed in a terminal of a user in the form of an app and/or a program to provide the messaging service.

The messaging service may provide a chat room in which the user may transmit and receive a message including data, such as text, to and from a partner designated by the user. The messaging service may provide the user with a function to provide a message by displaying data transmitted and received via the chat room. One or more users may join one chat room. For example, only a single user may join one chat room. In other words, the user may generate a chat room with themselves (or their own chat room) and/or may transmit and receive a message via the chat room with themselves. The user joining the chat room may share the content of the message, such as text and a picture transmitted and received in the chat room.

The server 120 may be linked to an app associated with a service executed by the user terminal 110 or to a web associated with the service for a user interface (UI), a function, an operation, or the service.

The user account may be generated by registering to a service provided by the server 120, and the server 120 may function as a service platform that provides the service to the user account registered to the service, such as a social networking service (SNS) or an IMS. In the embodiments of the present disclosure, the user account is mainly described as an account registered to an IMS. Since the user terminal 110 uses the service using the user account, the user account included in the below embodiments may correspond to the user terminal 110. In the embodiments of the present disclosure, the user account may be briefly referred to as an “account”.

For example, the messaging service may manage a chat room and a message corresponding to the user account. The user may transmit and receive a message via a chat room with other users who register for the IMS, via the account generated as the user registers to the IMS.

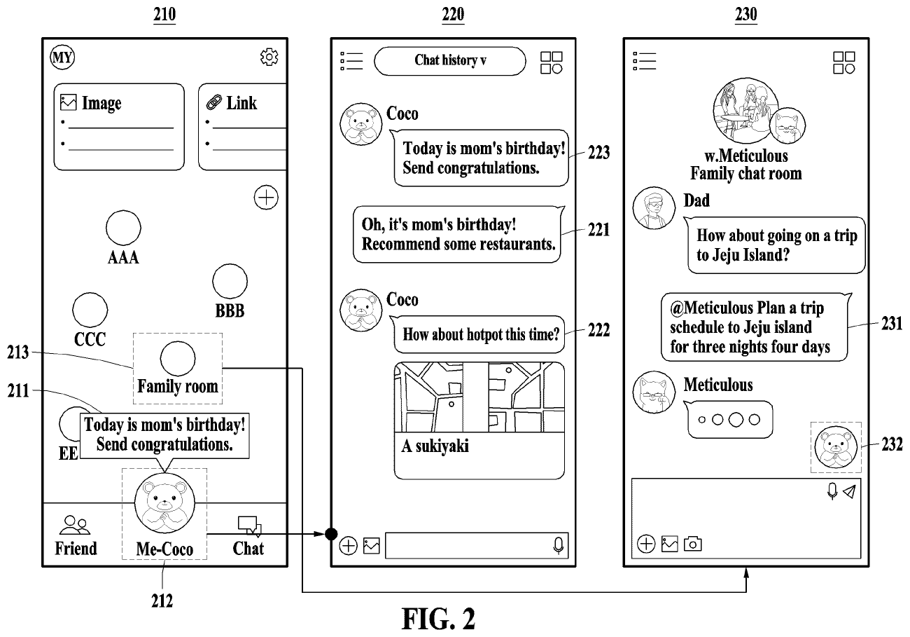

FIG. 2 illustrates an example of a screen provided via a messaging service according to an embodiment.

According to an embodiment, a messaging system (e.g., the messaging system 100 of FIG. 1) may provide a message generated by a server via a virtual character (e.g., a virtual secretary character). The virtual character may include a virtual character assigned to a user account or assigned to each chat room. In the embodiments of the present disclosure, the virtual character assigned to the user account may be referred to as a “virtual character of the user account”, “a personal mate of the user account”, or a “personal mate”, and the virtual character assigned to each chat room may be referred to as a “virtual character of the chat room”, a “group mate of the chat room”, or a “group mate”.

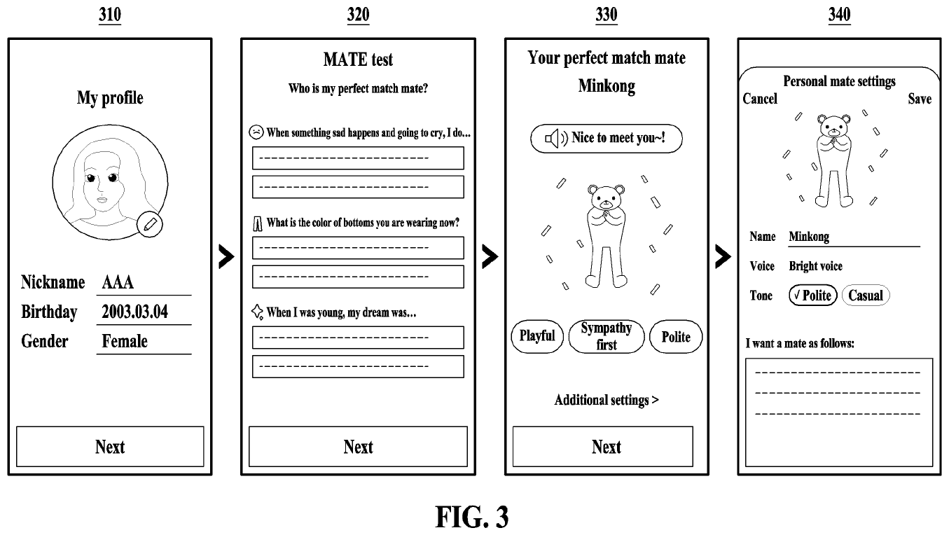

According to an embodiment, the personal mate and the group mate may be characters used to transmit a message generated by the server to the user and may be used to transmit a message received from the server in the form of a message received from the virtual character. A profile of at least one virtual character may be generated by a user's configuration. The generation of the profile of the virtual character is further described with reference to FIG. 3.

The server (e.g., the server 120 of FIG. 1) may transmit information to display a home screen of the messaging service to a user terminal (e.g., the user terminal 110 of FIG. 1). The home screen of the messaging service may refer to a default screen that is displayed when the user terminal executes an app for the messaging service and a specific condition (e.g., generation of a request to display a chat room corresponding to a specific chat room) is not met.

On a screen 210, the user terminal may display the home screen of the messaging service. The user terminal may display objects (e.g., an object 213) respectively corresponding to regular chat rooms in which the user account has joined and an object (e.g., an object 212) corresponding to a personal mate chat room. The personal mate chat room may refer to a chat room in which the personal mate and the user account have joined.

The regular chat room may be a type of chat room and may refer to a chat room in which the user account and another user account have joined. The regular chat room may include a one-on-one chat room in which the user account and another user account have joined, and a group chat room in which the user account and a plurality of other user accounts have joined.

The personal mate chat room may refer to a chat room in which the server and the user account have joined. The server may join the personal mate chat room as a personal mate. Since the server joins the personal mate chat room as the personal mate, the user may have user experiences of transmitting a message to the personal mate and receiving a message from the personal mate. The personal mate chat room may be a chat room in which no other user accounts have joined, and for example, may refer to a chat room in which only the server and the user account have joined. Hereinafter, in the embodiments of the present disclosure, a message transmitted from the server to the user account via the personal mate chat room may also be referred to as a “message of the personal mate”.

On a screen 210, in response to receiving a message of the personal mate from the server, the user terminal may display at least a portion 211 of the message of the personal mate on the home screen of the messaging service. In response to a user input (e.g., a user input to select the object 212) to select the personal mate chat room, the user terminal may transmit, to the server, a request to display a chat room screen corresponding to the personal mate chat room. The server may transmit, to the user terminal, information to display the chat room screen corresponding to the personal mate chat room.

On a screen 220, the user terminal may display the chat room screen corresponding to the personal mate chat room. The user terminal may receive a query message 221 to be transmitted to the server from the user account via the chat room screen corresponding to the personal mate chat room. The user terminal may transmit the query message 221 to the server. The server may generate a message 222 of the personal mate based on the query message 221.

When generating the message 222 of the personal mate, the server may use all messages accessible to the user account. For example, the server may select all messages (or message chunks), transmitted via the chat room that the user account joins, to be candidate messages (or candidate message chunks). The server may select, from the candidate messages (or the candidate message chunks), an input message (or an input message chunk) containing content required to generate the message 222 of the personal mate.

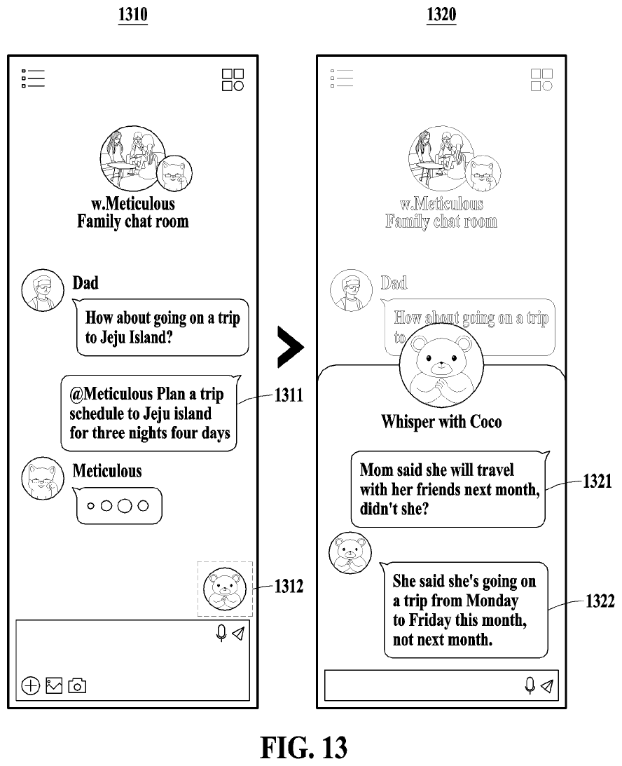

According to an embodiment, the server may determine the input message (or the input message chunk) based on whether each candidate message (or each candidate message chunk) contains the content required to generate the message 222 of the personal mate, based on an embedding vector of the candidate message (or the candidate message chunk). The server may generate the message 222 of the personal mate using the determined input message (or the input message chunk). In other words, the server may generate the message 222 of the personal mate by considering all messages provided to the user account (e.g., at least considering as a candidate message). When generating the message 222 of the personal mate, the server may determine a message (or a message chunk) transmitted via at least one of the personal mate chat room or other chat rooms that the user account joins to be the candidate message (or the candidate message chunk). The generation of the message of the personal mate is further described with reference to FIG. 13.

The embodiments of the present disclosure mainly describe that the server generates a response message to a query message in response to the query message received from the user account via a virtual character (e.g., the personal mate or group mate) and transmits the response message to the user account. However, the embodiments are not limited thereto.

For example, the server may generate a message of the virtual character based on meeting a condition to provide a proactive message. The server may transmit a message generated via a chat room in which the user account and the virtual character (e.g., the personal mate or group mate) have joined, to the user terminal. The condition to provide the proactive message may include at least one of arrival of the user's schedule, determination of an action to be recommended to the user, or meeting a trigger condition of a function of the server (or the virtual character).

Referring to the screen 210, the user terminal may detect a user input (e.g., a user input to select the object 213) to select a regular chat room in which the user account and another user account have joined. The user terminal may transmit to the server a request to display a chat room screen corresponding to the regular chat room. The server may transmit information to display the chat room screen corresponding to the regular chat room to the user terminal.

On a screen 230, the user terminal may display the chat room screen corresponding to the regular chat room in which the user account and another user account have joined. In the messaging service according to an embodiment, the server may further join each regular chat room in addition to the user account and another user account. The server may join the regular chat room as a group mate. Identical or similar to the personal mate, since the server joins the regular chat room as the group mate, the user may have user experiences of transmitting a message to the group mate and receiving a message from the group mate. Hereinafter, in the embodiments of the present disclosure, a message transmitted from the server to the user account and another user account via the regular chat room may also be referred to as a “message of the group mate”.

The user terminal may receive a query message 231 to be transmitted from the user account to the server and another user account via the regular chat room. The user terminal may transmit the query message 231 to the server. The server may generate a message of the group mate based on the query message 231 based on information indicating invocation of the server (or the group mate) included in the query message 231. For example, the information indicating invocation of the server may include a delimiter (e.g., “@”) representing invocation and text (e.g., “meticulous”) indicating the server (or the group mate).

When generating the message of the group mate, the server may use messages transmitted via a regular chat room (hereinafter, also referred to as a “specific chat room”) in which the query message 231 is transmitted. For example, the server may select the messages transmitted via the specific chat room to be candidate messages (or candidate message chunks). From the candidate messages (or the candidate message chunks), the server may select an input message (or an input message chunk) containing content required to generate the message of the group mate.

According to an embodiment, unlike the message of the personal mate provided only to the user account, the message of the group mate may also be provided to other user accounts that join the regular chat room together with the user account. Accordingly, the server may generate the message of the group mate by using the messages transmitted via the specific chat room and may exclude a message transmitted via other chat rooms (e.g., the personal mate chat room or other regular chat rooms) from generating the message of the group mate. The generation of the message of the group mate is further described with reference to FIG. 13.

According to an embodiment, the messaging service may support a function to invoke the personal mate chat room in the regular chat room. For example, on the screen 230, the user terminal may display a button 232 to invoke the personal mate chat room in the regular chat room. Via the function of the messaging service to invoke the personal mate chat room in the regular chat room, the user may transmit, to the server, a query message (e.g., a private query message) that is not disclosed to other user accounts joining the regular chat room and may receive, from the server, a response message (e.g., a private response message) that is not disclosed to other user accounts. The function to invoke the personal mate chat room in the regular chat room is further described with reference to FIG. 13.

FIG. 3 illustrates an example of an operation of generating a profile of a virtual character according to an embodiment.

According to an embodiment, a messaging system (e.g., the messaging system 100 of FIG. 1) may generate a profile of a virtual character based on a response of a user to a survey. According to an embodiment, the virtual character (e.g., the personal mate) assigned to the user account may be generated based on user information input by the user.

According to an embodiment, the user information may include basic information (e.g., gender, date of birth, and age) of the user and personality information of the user. The personality information of the user may include information about at least one of personality, tendency, temperament, or disposition of the user. The personal mate may interact (e.g., transmit and receive a message) mainly with the user and may not substantially interact with other users. Accordingly, the personal mate may be customized and provided to the user based on the user information.

A server (e.g., the server 120 of FIG. 1) may transmit, to a user terminal (e.g., the user terminal 110 of FIG. 1), information to display a screen (e.g., a survey screen) to input the user information. The user terminal may display the screen to input the user information.

For example, on a screen 310, the user terminal may display a first screen to input basic information. The user terminal may obtain the basic information of the user via the first screen.

On a screen 320, the user terminal may display a second screen to input personal information. The user terminal may obtain the personality information of the user via the second screen.

The user terminal may transmit the user information (e.g., the user information obtained via the first screen and/or the second screen) to the server. The server may receive the user information from the user terminal. The server may generate a profile of the virtual character of the user account based on the user information. The profile of the virtual character may include at least one of appearance of the virtual character (e.g., the design of the virtual character), a voice of the virtual character, a speech style of the virtual character, or personality of the virtual character.

On a screen 330, the server may transmit information to display information about the profile of the virtual character to the user terminal. The user terminal may display the profile of the virtual character of the user account generated based on the user information.

On a screen 340, the server may transmit information to display a screen for detailed configuration of the profile of the virtual character to the user terminal. The user terminal may obtain the information about detailed configuration of the profile of the virtual character from the user. For example, the user may input detailed configuration information indicating to change at least one of the appearance, voice, speech style, or personality of the virtual character. The user terminal may transmit a request to change the character including the detailed configuration information to the server. The server may change the profile of the virtual character based on the request to change the character.

Although not explicitly illustrated in FIG. 3, the server may transmit, to the user terminal, information to display the personal mate chat room as a chat room in which the personal mate and the user account have joined, based on the profile of the personal mate. The user terminal may display the personal mate chat room as a chat room in which the user account and the virtual character have joined.

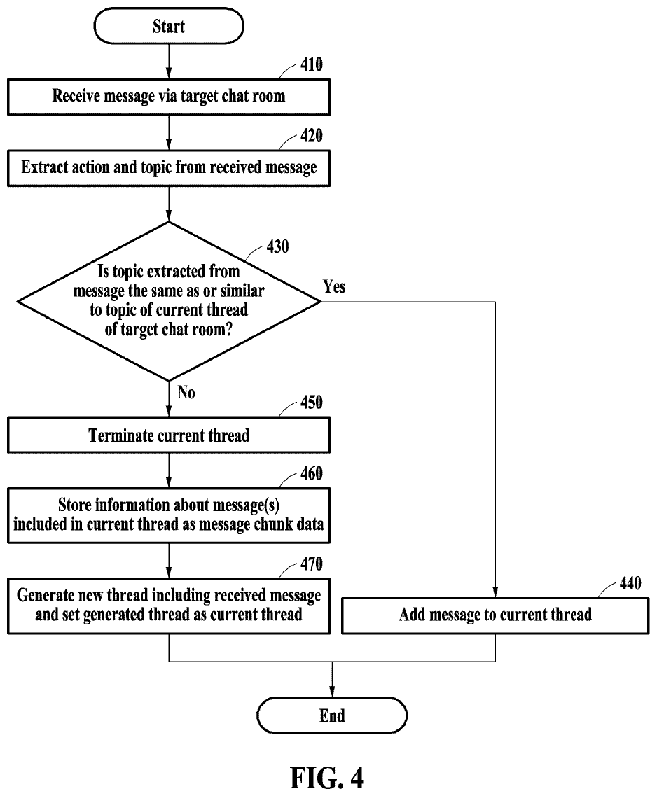

FIG. 4 is a flowchart of an example of a method of collecting chat data for each chat room by a server according to an embodiment.

According to an embodiment, a server (e.g., the server 120 of FIG. 1) may collect chat data for each chat room. The chat data may include a message transmitted via a corresponding chat room (e.g., a target chat room) and/or information extracted from the message. In the embodiments of the present disclosure, the chat data collected for each chat room may also be represented as short-term memory data.

The server may collect the chat data for each chat room based on a topic of a message. For example, for each chat room, the server may manage a current thread indicating a topic of the last message transmitted in the corresponding chat room. The current thread may include the last message and a previous message containing a topic that is the same as or similar to the last message. The topic of the current thread (hereinafter, also referred to as a “current topic”) may be extracted as a keyword or vector from messages included in the current thread. The server may extract the current topic from the current thread using a topic extraction model. The topic extraction model is further described with reference to operation 420.

In operation 410, the server may receive a message via a target chat room. The target chat room may be one of a chat room (e.g., a personal mate chat room) in which the user account and the server have joined, or a chat room (e.g., a regular chat room) in which user accounts (or the user accounts and the server) have joined.

In operation 420, the server may extract an action and a topic from the received message.

The action may be an action of the user shown in the message and may refer to a speech act or dialog act. For example, the action may include at least one of asking a question, replying, or requesting information.

According to an embodiment, the server may extract the action from the message using an action extraction model. The action extraction model may refer to a model generated and/or trained to output, from input data corresponding the message, output data corresponding to the action of the user shown in the message. The action extraction model may be implemented based on a machine learning model. For example, the action extraction model may include at least one of a neural network, a transformer, a large language model, or a reinforcement learning model.

The topic may refer to a subject that is discussed in the message. For example, the topic may be extracted as a keyword or vector corresponding to the topic.

According to an embodiment, the server may extract the topic from the message using the topic extraction model. The topic extraction model may refer to a model generated and/or trained to output, from input data corresponding the message, output data corresponding to the topic of the message. The topic extraction model may be implemented based on a machine learning model. For example, the topic extraction model may include at least one of a neural network, a transformer, a large language model, or a reinforcement learning model. The topic extraction model may be implemented as a single model integrated with the action extraction model, a model using a common network module (e.g., a software module or an operation set) with a portion of the action extraction model, or a separate model from the action extraction model.

In operation 430, the server may determine whether the topic extracted from the message is the same as or similar to the topic of the current thread (e.g., the current topic) of the target chat room. The server may determine whether the topic extracted from the message is the same as or similar to the current topic based on the result of comparing a similarity between the topic extracted from the message and the current topic of the current thread with a threshold similarity.

For example, the server may determine a similarity (e.g., a cosine similarity) between a vector of the topic extracted from the message and a vector of the current topic. The server may determine that the topic extracted from the message is the same as or similar to the topic of the current thread based on that the similarity is greater than or equal to the threshold similarity that is preset. The server may determine that the topic extracted from the message is different from the topic of the current thread based on that the similarity is less than the preset threshold similarity.

In operation 440, the server may add a message to the current thread based on determining that the topic extracted from the message is the same as or similar to the topic of the current thread. The server may update the current topic of the current thread (or a keyword or vector indicating the current topic) based on adding the message to the current thread.

In operation 450, the server may terminate the current thread based on determining that the topic extracted from the message is different from the topic of the current thread. When the last message (e.g., the message received in operation 410) transmitted via the target chat room contains a different topic from the topic of the current thread, the server may terminate the current thread and may generate a new thread including the last message (e.g., the message received from operation 410).

In operation 460, the server may store information about the messages included in the current thread as message chunk data. In the embodiments of the present disclosure, messages included in a single thread may be represented as a “message chunk”, and data including information extracted from the messages included in the single thread may be represented as “message chunk data”.

For example, the information about the messages included in the thread (e.g., current thread) may include at least one of identification information (e.g., a chat room identifier (ID)) of a chat room (e.g., the target chat room) in which the messages included in the thread are transmitted, identification information (e.g., a message ID) of the earliest message transmitted among the messages included in the thread, identification information (e.g., a message ID) of the latest message transmitted among the messages included in the thread, information about the current topic of the current thread (e.g., a keyword and/or vector corresponding to the current topic), summary information (e.g., summary text) that summarizes the messages included in the thread, or a priority score of the messages included in the thread.

The server may summarize the messages included in the current thread based on termination of the current thread. The server may obtain summary information including the result of summarizing (e.g., summary text) the messages included in the current thread according to five Ws and H.

The server may determine a priority score of the messages included in the current thread based on the termination of the current thread. The priority score may be used to adjust (e.g., increase) the possibility that the message chunk is used for the server to generate the message. For example, when the server selects a message chunk from the message chunks to generate the message (e.g., the message of the personal mate or the message of the group mate) of the server, the probability of selecting a message chunk having a high priority score may increase.

According to an embodiment, when the topic of the messages included in the current thread is the same as or similar to a specific topic that is preset, the priority score may be determined based on a score set with respect to the specific topic. The score set with respect to the specific topic may be set by the server or a service provider, and/or by the user. For example, the specific topic may include at least one of travel, move, family, or birthday.

In operation 470, the server may generate a new thread including the received message (e.g., the received message in operation 410) and may set the generated thread as a current thread. The server may determine a current topic of the newly generated current thread. For example, the server may determine the topic (e.g., the topic extracted in operation 420) extracted from the message to be the topic of the current thread.

The server may perform at least a portion of operations 410 to 470, in response to receiving the message via the target chat room. When receiving a plurality of messages via the target chat room, the server may obtain message chunks including the identification information of the target chat room and message chunk data about the message chunks by iteratively performing at least a portion of operations 410 to 470 based on each message.

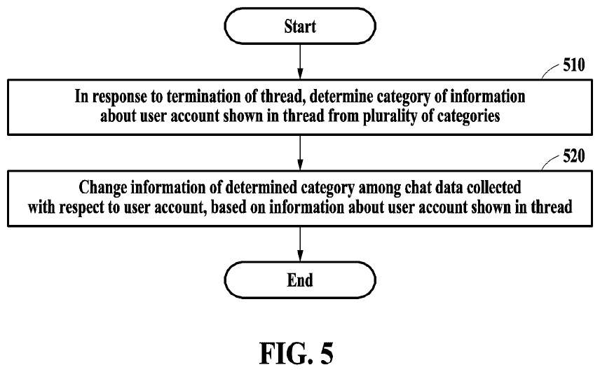

FIG. 5 is a flowchart of an example of a method of collecting chat data for each user account by a server according to an embodiment.

According to an embodiment, a server (e.g., the server 120 of FIG. 1) may collect chat data for each user account. The chat data collected with respect to the user account may include a message transmitted via one of chat rooms that the user account joins, and/or information extracted from the message. In the embodiments of the present disclosure, the chat data collected for each user account may also be represented as long-term memory data.

The chat data (e.g., the long-term memory data) collected for each user account may include information classified into a plurality of categories. The plurality of categories may include at least one of a profile category, a status category, a preference category, an episode category, a relationship category, or a communication style category.

The profile category may refer to a category indicating the basic information (e.g., information that is unlikely to change) of the user. For example, the information in the profile category may include information about at least one of name, date of birth, gender, nationality, place of residence, or birthplace.

The status category may refer to a category indicating a current status (e.g., a status that may change) of the user. For example, the information in the status category may include information about at least one of education (e.g., an education level, a spoken language, and a certificate), a job (e.g., career), a location (e.g., a work location and a residence location), physical (e.g., height, weight, medical history, surgical history, and mental health), or economic (e.g., income, expense, and an asset level).

The preference category may refer to a category indicating personal preference of the user. For example, the information in the preference category may include information about at least one of interest, hobby, habit, belief, value, plan (e.g., a long-term plan), or goal (e.g., a long-term goal).

The episode category may refer to a category indicating an episode of the user. For example, the information in the episode category may include information about at least one of an event, anniversary, schedule, experience, plan (e.g., a short-term plan), or goal (e.g., a short-term goal).

The relationship category may refer to a category indicating an interpersonal relationship of the user. For example, the information in the relationship category may include information about at least one of blood relative (e.g., family), lover, friend, community (e.g., company, church, alumni, fan club, or small community), or regional relationship (e.g., neighbor and acquaintance).

The communication style category may refer to a category indicating a communication style of the user or a communication style of a partner the user desires to listen. For example, the information in the communication style category may include information indicating a preferred conversation style (e.g., a direct style, an indirect style, or tone) of the user.

In the embodiments of the present disclosure, the information in category A may also be represented as “A information”.

The server may collect the message chunk data for each chat room as described above with reference to FIG. 4. The server may change (e.g., update) the chat data on each user account joining the target chat room based on the termination of the current thread of the target chat room.

In operation 510, in response to the termination of the thread, the server may determine the category of the information about the user account shown in the thread (or message chunk) from the plurality of categories. The server may determine the category of the information about the user account shown in the thread (or message chunk) from the plurality of categories of the long-term memory data.

According to an embodiment, the server may determine that the information in various categories about the user account is shown in the thread. Based on the information shown in the thread, the server may change each piece of information of the determined category among the chat data collected with respect to the user account.

According to an embodiment, the server may determine the category of the information about the user account shown in the message chunk using a category determination model. The category determination model may refer to a model generated and/or trained to output, from input data corresponding to the message chunk, output data corresponding to the category of the information about the user account shown in the message chunk. The category determination model may be implemented based on a machine learning model. For example, the category determination model may include at least one of a neural network, a transformer, a large language model, or a reinforcement learning model.

According to an embodiment, the server may independently (e.g., differently) determine the information shown in the message chunk corresponding to the terminated thread or the category of the information for each user account. For example, a first user account and a second user account may join the target chat room. The server may extract information about the first user account and information about the second user account from the terminated thread based on that the thread is terminated in the target chat room. For example, the server may obtain (e.g., determine) that a user of the first user account has a cold from the thread. For the first user account, the server may determine a category of the information shown in the thread to be the status category. For the second user account, the server may determine a category of the information shown in the thread to be the episode category.

In operation 520, the server may change the information of the determined category among the chat data collected with respect to the user category based on the information shown in the thread with respect to the user account.

According to an embodiment, the server may add the information shown in the thread (or message chunk) to the information of the determined category among the chat data collected with respect to the user account. The server may store (e.g., tag or map) the information shown in the thread together with information about a reference time of the thread. The reference time of the thread may be determined based on at least one of a transmission time of the earliest message transmitted among the messages included in the thread or a transmission time of the latest message transmitted. When a plurality of pieces of information included in chat data of a specific category are different (e.g., contradictory), the server may preferentially use information collected recently rather than other information by storing information about the time in the chat data of the specific category.

According to an embodiment, the server may collect the chat data (e.g., chat data collected for each user account and long-term memory data) on the user account using chat data (e.g., chat data collected for each chat room and short-term memory data) collected from the plurality of chat rooms in which a specific user account has joined. As a result, the chat data collected with respect to the user account may be data based on messages transmitted in the plurality of chat rooms in which the user account has joined.

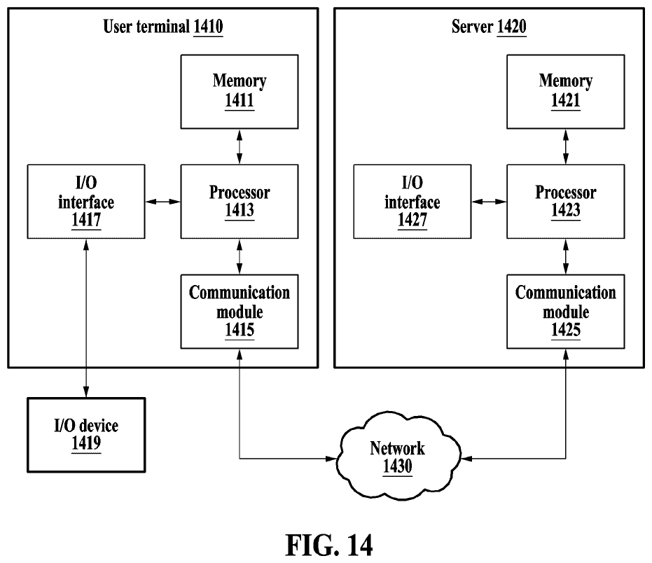

When generating a message of the personal mate as described above with reference to FIG. 2, the server according to an embodiment may use a message transmitted in chat rooms in which the user account has joined. In addition, when generating a message of the group mate, the server may use a message transmitted in the chat room corresponding to the group mate and may not use a message transmitted in other chat rooms. As a result, when generating the message of the personal mate, the server may use the chat data (e.g., data based on the messages transmitted in the plurality of chat rooms in which the user account has joined) collected for the user. When generating the message of the group mate, the server may exclude the chat data (e.g., including the data based on the message transmitted in other chat rooms in which the user account has joined) collected for the user and may use the message chunk data based on the message transmitted in the chat room corresponding to the group mate. The generating of the message of the personal mate and the generating of the message of the group mate are further described with reference to FIG. 14.

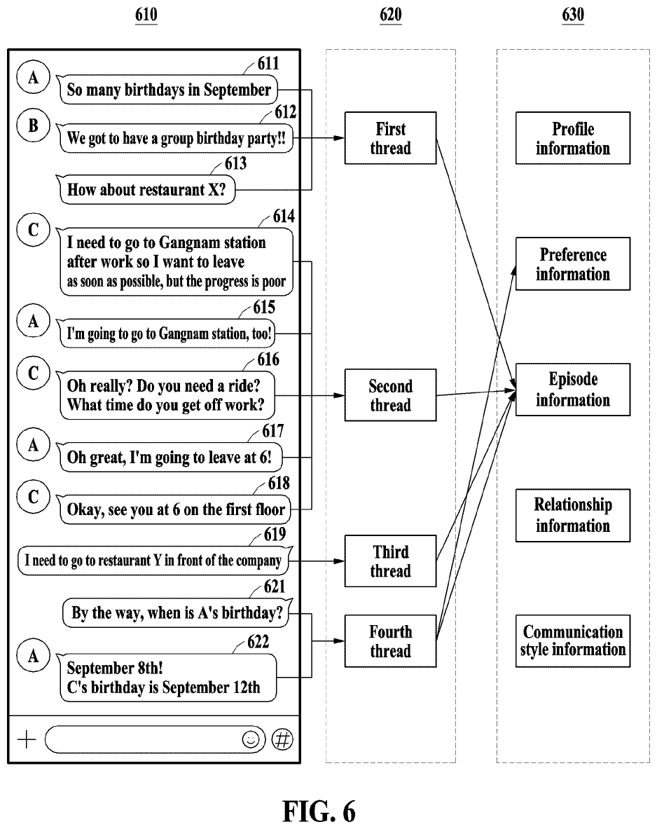

FIG. 6 illustrates an example of an operation of collecting chat data by a server according to an embodiment.

According to an embodiment, the server may receive a plurality of messages via a target chat room. The server may collect short-term memory data 620 on the target chat room and long-term memory data 630 on a user account using the plurality of messages.

Referring to FIG. 6, on a screen 610, a user terminal may display a chat room screen corresponding to a chat room. User accounts A, B, C, and D may join the target chat room. In FIG. 6, the user terminal that displays a screen 610 may be a user terminal connected with user account D.

The server may generate a first thread including a first message 611 in response to receiving the first message 611 (e.g., “So many birthdays in September”) from user account A via the target chat room. The server may set the first thread as a current thread of the target chat room and may determine a topic of the first thread to be “September birthdays”.

In response to receiving a second message 612 (e.g., “We got to have a group birthday party!!”) via the target chat room from user account B, the server may determine a topic of the second message 612 to be “birthday party” and may determine that the topic (e.g., “September birthdays”) of the current thread (e.g., the first thread) is similar to the topic (e.g., “birthday party”) of the second message 612. The server may add the second message 612 to the first thread. The server may determine the topic of the first thread, to which the second message 612 is added, to be “birthday”.

In response to receiving a third message 613 (e.g., “How about restaurant X?”) via the target chat room from user account B, the server may determine a topic of the third message 613 to be “birthday party venue” and may determine that the topic (e.g., “birthday”) of the current thread (e.g., the first thread) is similar to the topic (e.g., “birthday party venue”) of the third message 613. The server may add the third message 613 to the first thread. The server may determine the topic of the first thread, to which the third message 613 is added, to be “birthday”.

In response to receiving a fourth message 614 (e.g., “I need to go to Gangnam station after work so I want to leave as soon as possible, but the progress is poor”) via the target chat room from user account C, the server may determine a topic of the fourth message 614 to be “schedule after work” and may determine that the topic (e.g., “birthday”) of the current thread (e.g., the first thread) is different from the topic (e.g., “schedule after work”) of the fourth message 614. The server may terminate the first thread and may generate a second thread including the fourth message 614. The server may determine the topic of the second thread to be “schedule after work”.

The server may store message chunk data extracted from the first thread in the short-term memory data 620 in response to the termination of the first thread. In response to the termination of the first thread, the server may store information about each user account (e.g., user accounts A, B, C, and D) shown in the first thread. For example, the server may determine a category of information about user account D shown in the first thread to be the episode category. The server may add the information (e.g., information indicating that “a group birthday party will be held in September”) about user account D shown in the first thread to the information of the episode category in the long-term memory data 630 on user account D.

In response to receiving a fifth message 615 (e.g., “I'm going to go to Gangnam station, too!”) via the target chat room from user account A, the server may determine a topic of the fifth message 615 to be “schedule after work” and may determine that the topic (e.g., “schedule after work”) of the current thread (e.g., the second thread) is the same as the topic (e.g., “schedule after work”) of the fifth message 615. The server may add the fifth message 615 to the second thread. The server may determine the topic of the second thread, to which the fifth message 615 is added, to be “schedule after work”.

Similar to acquisition of the fifth message 615, the server may sequentially receive a sixth message 616 (e.g., “Oh really? Do you need a ride? What time do you get off work?), a seventh message 617 (e.g., “Oh great, I'm going to leave at 6!”), and an eighth message 618 (e.g., “Okay, see you at 6 on the first floor”) via the target chat room. For each of the sixth message 616, the seventh message 617, and the eighth message 618, the server may determine whether the topic of the corresponding message is the same or similar to the topic of the second thread and may add the corresponding message to the second thread.

In response to receiving a ninth message 619 (e.g., “I need to go to restaurant Y in front of the company”) via the target chat room from user account D, the server may determine a topic of the ninth message to be “restaurant Y” and may determine that the topic of the ninth message is different from the topic (e.g., “schedule after work”) of the current thread (e.g., the second thread). The server may terminate the second thread and may generate a third thread including the ninth message 619. The server may set the third thread as the current thread of the target chat room and may determine the topic of the third thread to be “restaurant Y”.

In response to the termination of the second thread, the server may store message chunk data extracted from the second thread in the short-term memory data 620. The server may store information on each user account shown in the second thread in response to the termination of the second thread. For example, the server may determine a category of information about user account D shown in the second thread to be the episode category. The server may add the information (e.g., information indicating that “A and C will leave work together and go to Gangnam station after work on day DD of month MM, year of YYYY”) about user account D shown in the second thread to the information of the episode category in the long-term memory data 630 on user account D.

In response to receiving a tenth message 621 (e.g., “By the way, when is A's birthday?”) via the target chat room from user account D, the server may determine a topic of the tenth message 621 to be “A's birthday” and may determine that the topic of the tenth message 621 is different from the topic (e.g., “schedule after work”) of the current thread (e.g., the second thread). The server may terminate the third thread and may generate a fourth thread including the tenth message 621. The server may set the fourth thread as the current thread of the target chat room and may determine a topic of the fourth thread to be “A's birthday”.

In response to the termination of the third thread, the server may store message chunk data extracted from the third thread in the short-term memory data 620. The server may store information on each user account shown in the third thread in response to the termination of the third thread. For example, the server may determine a category of information about user account D shown in the third thread to be the preference category and the episode category. The server may add the information (e.g., information indicating that “user account D wants to go to restaurant Y” and/or “user account D user account D is going to go to restaurant Y”) about user account D shown in the third thread to the information of the preference category and the information of the episode category in the long-term memory data 630 on user account D. In response to receiving an eleventh message 622 (e.g., “September 8th! C's birthday is September 12th”) via the target chat room from user account A, the server may determine a topic of the eleventh message 622 to be “A and C's birthdays” and may determine that the topic (e.g., “A's birthday”) of the current thread (e.g., the fourth thread) is similar to the topic (e.g., “A and C's birthdays”) of the eleventh message 622.

The server may add the eleventh message 622 to the fourth thread. The server may determine the topic of the fourth thread, to which the eleventh message is added, to be “birthday”.

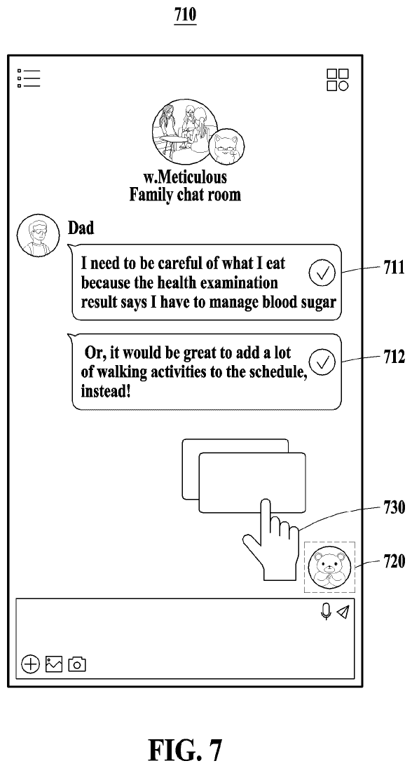

FIG. 7 illustrates an example of an operation of a server to add a specific message to chat data collected with respect to a user account according to an embodiment.

According to an embodiment, a server (e.g., the server 120 of FIG. 1) may receive a request to add a specific message to chat data from a user terminal (e.g., the user terminal 110 of FIG. 1). The server may collect the chat data based on a message transmitted via a chat room, but at least a portion of content included in the message may be lost while collecting the chat data. A user may select the specific message including desired content to be considered (e.g., considered in detail or precisely considered) when generating a message (e.g., a message of the personal mate or a message of the group mate) of the server.

On a screen 710, the user terminal may detect a user input with respect to the specific message being considered for the server to generate the message. For example, referring to FIG. 7, the user terminal may detect an input 730 to drag specific messages 711 and 712 of another user account to an area 720 corresponding to the personal mate, wherein the specific messages 711 and 712 are transmitted via a regular chat room (e.g., a chat room in which the user account and the other user account have joined). The user terminal may transmit a memory request of the specific messages 711 and 712 to the server.

The server may change (e.g., add or adjust) chat data (e.g., the long-term memory data or short-term memory data) related to the specific messages 711 and 712, in response to receiving the memory request. For example, the server may increase a priority score of message chunk data including the specific messages 711 and 712. For example, the server may add the specific messages 711 and 712 to the long-term memory data on the user account. When adding the specific messages 711 and 712 designated by the memory request to the long-term memory data, the server may add the content or substantially the same content of the specific messages 711 and 712 to the long-term memory data.

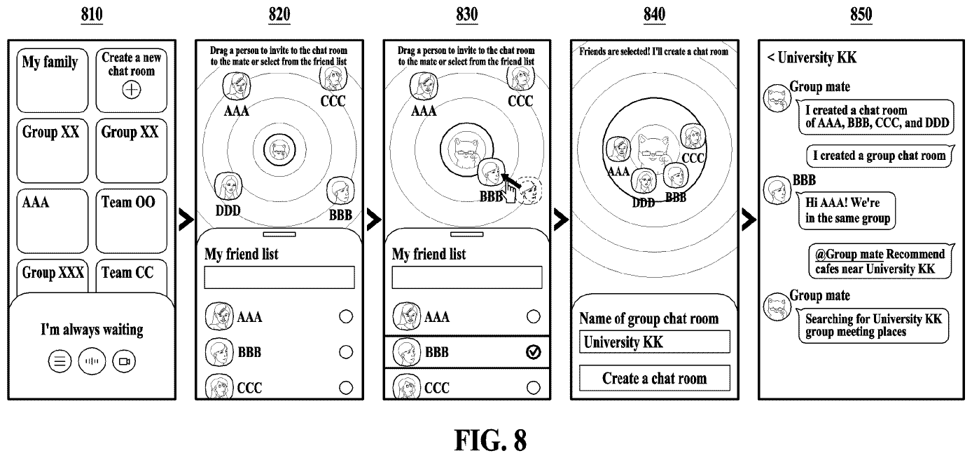

FIGS. 8, 9, and 10 illustrate examples of a function to recommend an account to be invited to a chat room in a messaging service according to an embodiment.

According to an embodiment, in a messaging service, an account to be invited to a chat room (e.g., a regular chat room) may be recommended.

A user terminal (e.g., the user terminal 110 of FIG. 1) may transmit, to a server (e.g., the server 120 of FIG. 1), a recommendation request of the account to be invited to the chat room. The server may receive, from the user terminal, the recommendation request of the account to be invited to the chat room. An invitation request may be for recommending an account to be invited to a newly created chat room or recommending an account to be additionally invited to a chat room which is already created and in which one or more user accounts have joined.

The server may determine a recommended account based on the recommendation request. According to an embodiment, the server may determine the recommended account to be at least one of an account that uses a terminal positioned near the user terminal among friend accounts registered as friends in the user account, an account that uses a terminal obtaining the same or similar motion input obtained from the user terminal, or an account determined from the friend accounts based on text describing the chat room. The motion input may refer to a user input detected by a motion applied to the user terminal. For example, the motion input may include an input that is detected when the user shakes, rotates, tilts, and/or moves the user terminal.

According to an embodiment, the recommendation request may include information indicating a condition related to the recommended account.

For example, as the condition related to the recommended account, when the recommendation request includes information indicating that the recommended account is an account using a terminal positioned near the user terminal among the friend accounts, the server may determine the account using the terminal positioned near the user terminal among the friend accounts, to be the recommended account.

For example, as the condition related to the recommended account, when the recommendation request includes information indicating that the recommended account is an account using a terminal positioned near the user terminal and obtaining a specific motion input, the server may determine an account using the terminal positioned near the user terminal and obtaining a motion input that is the same as or similar to the specific motion input, to be the recommended account. The recommendation request may include information about the specific motion input. For example, the specific motion input may be determined based on a motion input obtained from the user terminal.

For example, based on that the recommendation request includes text describing the chat room, the server may determine an account related to the text to be the recommended account. For example, the text describing the chat room may include information about the relationship (e.g., blood relative, regional relationship, friend, community, or lover) between the user account and the recommended account. As described above with reference to FIG. 5, the server may determine the recommended account based on information of which the category is classified into the relationship among the chat data (e.g., long-term memory data) collected for the user account.

The server may transmit, to the user terminal, information to display information related to the determined recommended account. Based on the information received from the server, the user terminal may display information about at least one of an account that uses a terminal positioned near the user terminal among friend accounts registered as friends in the user account, an account that uses a terminal that obtains a motion input that is the same as or similar to a motion input obtained from the user terminal, or a determined account from the friend accounts based on text describing the chat room, as the information about the recommended account.

Referring to FIG. 8, the server may recommend a friend account positioned near the user terminal.

On a screen 810, the user terminal may transmit, to the server, a recommendation request of an account to be invited to a new chat room, based on a user input. The server may determine the account near the user terminal to be the recommended account from the friend accounts. The server may transmit information to display the information about the recommended account to the user terminal.

On a screen 820, the user terminal may display the information about the recommended account. In FIG. 8, for example, the user terminal may display information about a position of each recommended account and/or information registered with respect to each recommended account. The information about the position of each recommended account may include a distance and/or direction to the position of the recommended account from the position of the user account. In the embodiments of the present disclosure, a position of an account may refer to a position of a terminal that accesses an IMS with the account. The information registered with respect to each recommended account may include the name of the recommended account and/or at least a portion (e.g., a profile image) of the profile of the recommended account.

On a screen 830, the user terminal may display a screen to select an account to invite to the chat room from the recommended accounts. The user terminal may select at least one of the recommended accounts based on the user input.

On a screen 840, the user terminal may display a screen to receive information about the chat room. For example, the user terminal may display a screen to set a name of the chat room. The user terminal may obtain the name of the chat room based on the user input.

The user terminal may transmit, to the server, a generation request to generate a chat room and/or an invitation request to invite an account. The server may generate the chat room using information (e.g., the name of the chat room) about the chat room included in the generation request. The server may add a selected account to the generated chat room or may transmit a join request to join the generated chat room to the selected account using identification information of the selected account included in the invitation request. The server may transmit information to display a chat room screen corresponding to the generated chat room to the user terminal.

On a screen 850, the user terminal may display the chat room screen corresponding to the chat room to which the selected account is invited.

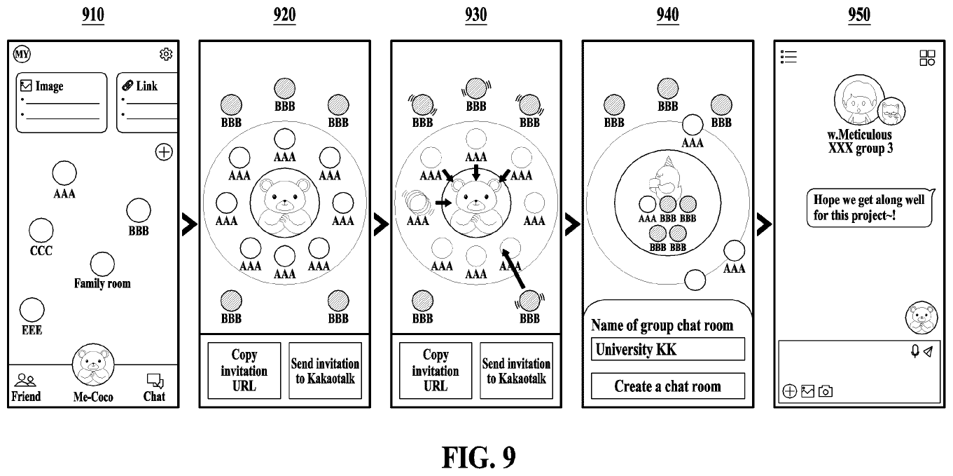

Referring to FIG. 9, the server may recommend an account that is positioned near the user terminal and obtains a motion input that is the same as or similar to a specific motion input.

On a screen 910, the user terminal may transmit, to the server, a recommendation request to recommend an account to invite to a new chat room based on a user input. In response to receiving the recommendation request from the user terminal, the server may determine candidate accounts using terminals positioned near the user terminal. The server may transmit information to display information about the candidate accounts to the user terminal.

On a screen 920, the user terminal may display the information about the candidate accounts. The information about each candidate account may include information about a position of the candidate account (e.g., a distance and/or direction to the candidate account from the user account) and/or information registered with respect to the candidate account (e.g., at least a portion of the profile and the name).

The server may determine an account using a terminal that obtains a motion input that is the same as or similar to a specific motion input, to be the recommended account. The server may transmit information to display the information about the recommended account to the user terminal.

On a screen 930, the user terminal may display the information about the recommended account. For example, as shown in FIG. 9, the user terminal may apply an additional visual effect to a graphic object corresponding to the recommended account among the candidate accounts.

The server may determine an account to be invited to the chat room based on a user input to determine the recommended account and/or select at least one of the recommended accounts. For example, the server may determine an account, which is determined to be the recommended account, to be the account to invite to the chat room. For example, among accounts determined to be the recommended accounts, the server may determine an account, which is selected based on the user input, to be the account to invite to the chat room.

On a screen 940, the user terminal may display a screen to receive information about the chat room. For example, the user terminal may display a screen to set a name of the chat room. The user terminal may obtain the name of the chat room based on the user input.

As described with reference to FIG. 8 or similar to the description, the user terminal may transmit, to the server, a generation request to generate a chat room and/or an invitation request to invite an account. The server may generate the chat room using information (e.g., the name of the chat room) about the chat room included in the generation request. The server may add an account to be invited to the generated chat room or transmit a join request to join the generated chat room to the account to be invited using identification information of the account to be invited to the chat room. The server may transmit information to display a chat room screen corresponding to the generated chat room to the user terminal.

On a screen 950, the user terminal may display the chat room screen corresponding to the chat room to which the selected account is invited.

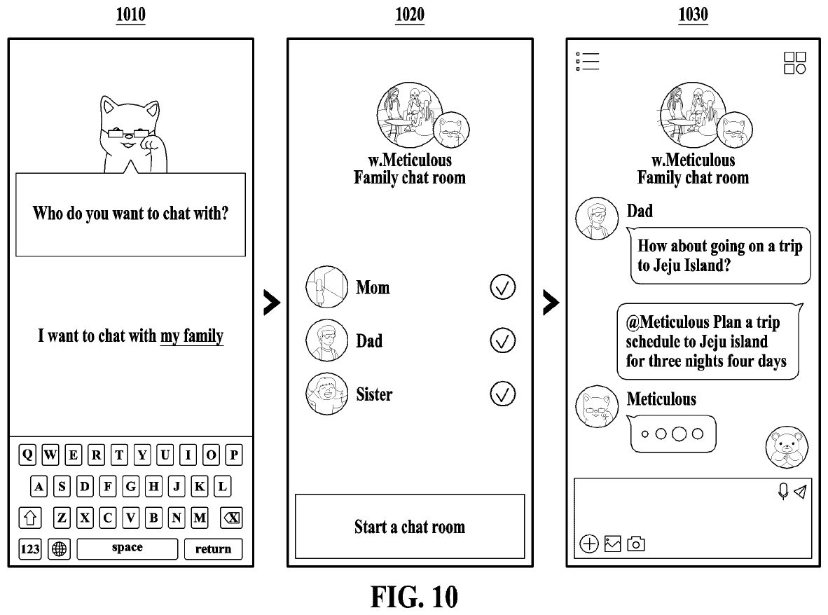

Referring to FIG. 10, the server may recommend an account based on text describing a chat room.

On a screen 1010, the user terminal may display a screen input text describing the chat room. The user terminal may obtain the text describing the chat room based on a user input. The user terminal may transmit a recommendation request including the information about the text describing the chat room to the server.

In response to receiving the recommendation request, the server may determine a recommended account using chat text collected with respect to the user account, and the text describing the chat room. The server may transmit information to display the information about the recommended account to the user terminal.

On a screen 1020, the user terminal may display the information about the recommended account. The user terminal may obtain a user input to select an account to be invited to the chat room from the recommended account. The user terminal may transmit the information about the account to be invited to the chat room and a generation request to generate the chat room.

The server may generate the chat room based on the generation request. The server may determine information (e.g., a name of the chat room and a representative image of the chat room) about the chat room based on the text describing the chat room. The server may add an account to be invited to the generated chat room or transmit a join request to join the generated chat room to the account to be invited using identification information of the account to be invited to the chat room. The server may transmit information to display a chat room screen corresponding to the generated chat room to the user terminal.

On a screen 1030, the user terminal may display the chat room screen corresponding to the chat room to which the selected account is invited.

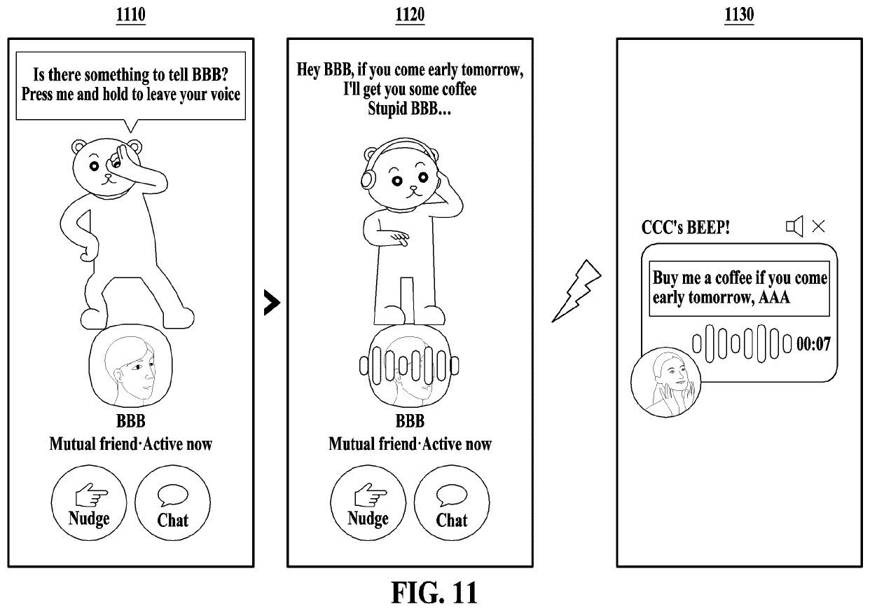

FIG. 11 illustrates an example of a function to transmit content to another user account using a personal mate in a messaging service according to an embodiment.

According to an embodiment, a server (e.g., the server 120 of FIG. 1) may generate a personal mate for each user account. Independently of the chat room, the server may provide a function to transmit content using the personal mate between user accounts.

In the profile of the user account, the server may provide information to display a virtual character (e.g., the personal mate) to a user terminal (e.g., the first user terminal) accessing with the user account (e.g., the first user account) or another user terminal (e.g., the second user terminal) accessing with another user account (e.g., the second user account).

On a screen 1110, the second user terminal may display a profile screen of the first user account. The profile screen of the first user account may include a graphic object corresponding to the virtual character of the first user account.

On a screen 1120, the second user terminal may obtain content based on a user input with respect to the graphic object corresponding to the virtual character. For example, while detecting a touch input to press the graphic object corresponding to the virtual character, the second user terminal may obtain sound data (e.g., voice data) obtained via an input device (e.g., a microphone) of the second user terminal as the content.

The second user terminal may transmit a content transmission request to transmit the content to the first user account using the virtual character of the first user account. The server may receive the content transmission request to transmit the content to the first user account from the second user account via the virtual character.

The server may transmit, to the first user terminal, information to output the content corresponding to the content transmission request via the virtual character of the first user account in the profile of the first user account.

On a screen 1130, the first user terminal may output the content corresponding to the content transmission request via the virtual character in the profile of the first user account in response to the content transmission request.

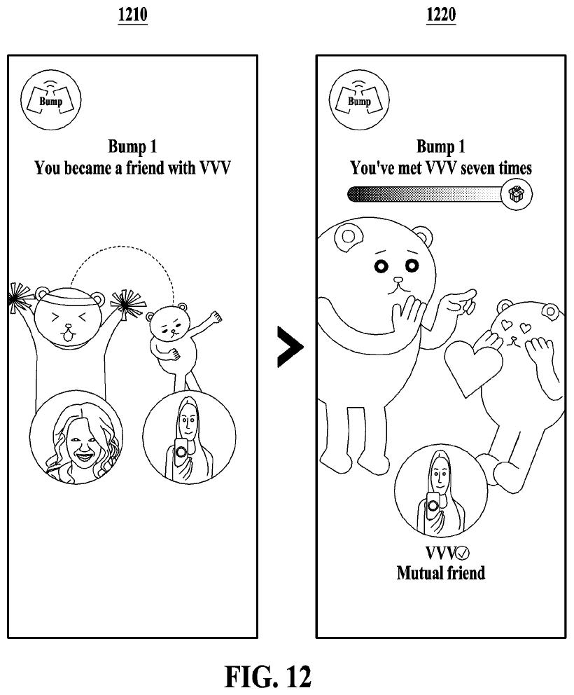

FIG. 12 illustrates an example of a function to display information indicating interactions among virtual characters of user accounts according to an embodiment.

A first user terminal (e.g., the user terminal 110 of FIG. 1) according to an embodiment may receive identification information of a second user account of a second user terminal from the second user terminal in response to contacting or approaching the second user terminal. The second user terminal may receive identification information of a first user account of the first user terminal from the first user terminal. According to an embodiment, the exchange of the identification information of the first user account and the identification information of the second user account between the first user terminal and the second user terminal may be performed based on short-range communication (e.g., Bluetooth and near field communication (NFC)).

A user terminal (e.g., the first user terminal or the second user terminal) and/or a server (e.g., the server 120 of FIG. 1) may determine whether the other user account is registered as a friend of the user account based on the identification information of the other user account.

For example, the user terminal may transmit a friend addition request to register the other user account as a friend of the user account to the server based on the determination that the other user account is not registered as a friend of the user account. Based on the friend addition request and/or the determination that the other user account is not registered as a friend of the user account, the server may register the other user account as a friend of the user account. The server may register the user account as a friend of the other user account. The server may transmit, to the user terminal and the other user terminal, information to display a screen indicating that the user account and the other user account register each other as friends.

On a screen 1210, the user terminal and/or the other user terminal may display the screen indicating that the user account and the other user account register each other as friends. According to an embodiment, the screen indicating that the user account and the other user account register each other as friends may include a graphic object corresponding to a virtual character of the user account and a graphic object corresponding to a virtual character of the other user account.

For example, the user terminal may transmit information indicating that an interaction (e.g., contact or approach between terminals) between the other user account and the user account has occurred to the server in response to the determination that the other user account is registered as a friend of the user account. In response to receiving the information indicating that the interaction between the other user account and the user account has occurred and/or determining that the other user account is registered as a friend of the user account, the server may increase a friendship point between the user account and the other user account. The server may transmit the information to display a screen indicating that the friendship point between the user account and the other user account has increased to the user terminal and the other user terminal.

On a screen 1220, the user terminal and/or the other user terminal may display the screen indicating that the friendship point between the user account and the other user account has increased. According to an embodiment, the screen indicating that the friendship point between the user account and the other user account has increased may include the graphic object corresponding to the virtual character of the user account and the graphic object corresponding to the virtual character of the other user account.

FIG. 13 illustrates an example of a function to invoke a personal mate chat room in a regular chat room according to an embodiment.

According to an embodiment, a server (e.g., the server 120 of FIG. 1) may provide a function to invoke a personal mate chat room in a regular chat room. The server may provide the personal mate chat room connected to the regular chat room. In the embodiments of the present disclosure, a second chat room (e.g., the personal mate chat room) connected to a first chat room (e.g., the regular chat room) may include the second chat room (e.g., the personal mate chat room) subordinate to the first chat room (e.g., the regular chat room).

According to an embodiment, the connection of the second chat room to the first chat room may include that an entry of the user account to the second chat room (or the user account leaves the second chat room) is performed in response to an entry of the user account to the first chat room (or the user account leaves the first chat room). According to an embodiment, the connection of the second chat room to the first chat room may include that a user input, which is obtained from a screen (e.g., a first chat room screen) corresponding to the first chat room, is required to display a screen (e.g., a second chat room screen) corresponding to the second chat room.

A third chat room being independent of the first chat room may include that, independent of an entry of the user account to one of the first chat room and the third chat room (or the user account leaves the one of the first chat room and the third chat room), an entry of the user account to the other one of the first chat room and the third chat room is performed.

According to an embodiment, the server may transmit information to display the first chat room screen corresponding to the first chat room to a user terminal (e.g., the user terminal 110 of FIG. 1) using an IMS with the user account. The first chat room may be a regular chat room and may include a chat room in which the user account and other user accounts have joined. The user terminal may receive information to display the first chat room screen from the server. The user terminal may display the first chat room screen corresponding to the first chat room.

According to an embodiment, the first chat room may be a chat room in which the user account, the other user account, and the server (e.g., the group mate) have joined. On a screen 1310, the user terminal may obtain a first query message 1311 (e.g., a query message to be transmitted via the first chat room) via the first chat room. The user terminal may transmit the first query message 1311 input via the first chat room to the server. For example, the first query message 1311 may include information (e.g., information indicating invocation of the server, a delimiter, and text indicating the server, “@meticulous” in FIG. 13) requesting a response from the server.

The server may transmit information to display the first query message 1311 to the other user terminal using the IMS with the other user account. Since the first query message 1311 is a message transmitted via the first chat room, the first query message 1311 may be transmitted to the other user account joining the first chat room. In the embodiments of the present disclosure, the first query message 1311 may also be referred to as a “public query message” because the first query message 1311 is disclosed to the other user account joining the first chat room.

The server may generate a first response message to the first query message 1311. When generating the first response message, the server may exclude a message transmitted via a chat room other than the first chat room. The other chat room may include at least one of the second chat room connected to the first chat room and the third chat room independent of the first chat room. The first chat room may be a regular chat room in which the user account and the other user account have joined, and a message of the server to be transmitted via the regular chat room may be a message of the group mate.

Consequently, as described above with reference to FIGS. 2 to 6, the server may not use the message transmitted via the other chat room other than the first chat room to generate the first response message to the first query message 1311. As described above with reference to FIGS. 4 to 6, the server may store information about message chunks (or threads) collected for each chat room that the user account has joined, as chat data (e.g., short-term memory data) on the chat room. The server may determine a target message chunk associated with the first query message 1311 from the message chunks transmitted via the first chat room. The server may determine the target message chunk based on a similarity (e.g., a cosine similarity) between information (e.g., a vector of the first query message 1311) about the first query message 1311 and information about each message chunk (e.g., a vector of each message chunk). The vector of the first query message 1311 or the vector of the message chunk may be obtained using a vector extraction model (e.g., the topic extraction model of FIG. 4).

The server may generate the first response message based on the target message chunk among the message chunks transmitted via the first chat room. According to an embodiment, the server may generate the first response message using a response generation model. The response generation model may be a model generated and/or trained to output, from input data corresponding to information about the target message chunk (e.g., the original messages included in the target message chunk and a summary of the original message chunk) and the first query message 1311, output data corresponding to the first response message. The response generation model may be implemented based on a machine learning model. For example, the response generation model may include at least one of a neural network, a transformer, a large language model, or a reinforcement learning model. As described below, the server may input information about the message chunk transmitted via other chat rooms and/or chat data (e.g., long-term memory data) collected with respect to the user account to the response generation model to generate a second response message 1322 to be transmitted via the second chat room.

The server may transmit the first response message via the first chat room to the user terminal and the other user terminal. Similar or identical to the first query message 1311, the first response message may be provided to the other user account. The server may transmit the first response message via the first chat room to the other user terminal of the other user account. Since the first response message is a message transmitted via the first chat room, the first response message may be transmitted to the other user account joining the first chat room. In the embodiments of the present disclosure, the first response message may also be referred to as a “public response message” because the first response message is disclosed to the other user account joining the first chat room.

Although not explicitly shown in the screen 1310 of FIG. 13, the user terminal and/or the other user terminal may display the first response message on the first chat room screen in response to receiving the first response message to the first query message 1311 from the server.

On the screen 1310, the user terminal may obtain a user input to invoke the second chat room in the first chat room screen. The second chat room may be a chat room connected to the first chat room and may be a chat room (e.g., the personal mate chat room) between the user account and a virtual subject assigned to the user account. In the embodiments of the present disclosure, the virtual subject may be implemented based on a server, an agent (e.g., a virtual agent, an artificial intelligence (AI) agent), a user terminal (e.g., an AI model stored in the user terminal), and/or a virtual character. For example, the second chat room may be a chat room (e.g., the personal mate chat room) between the user account and the server. The second chat room may include a chat room for conversation between the user account and the server and/or notification. For example, the user terminal may obtain a user input to select a button 1312 corresponding to the second chat room included in the first chat room screen. The user terminal may transmit information about the user input to invoke the second chat room to the server.

The server may transmit information to display a second chat room screen corresponding to the second chat room based on the user input to invoke the second chat room. As described above, the user input may be obtained from the first chat room screen.

On a screen 1320, the user terminal may display the second chat room screen. According to an embodiment, the second chat room screen may be displayed as an overlay on at least a portion of the first chat room screen.

For example, the server may transmit, to the user terminal, information to generate a layer to display an overlay on the first chat room screen and render the second chat room screen on the generated layer. The user terminal may generate a layer to display an overlay on the first chat room screen. The user terminal may render the second chat room screen on the generated layer.

The user terminal may obtain a second query message 1321 via the second chat room. The user terminal may transmit, to the server, the second query message 1321 input via the second chat room.

When the server receives the second query message 1321 input via the second chat room from the user terminal, the server may generate the second response message 1322 based on at least one of messages transmitted via the first chat room.

According to an embodiment, the second response message 1322 may be generated based on a message transmitted via other chat rooms (e.g., the second chat room and the third chat room) that the user account has joined in addition to the message transmitted via the first chat room. The other chat rooms may include at least one of the second chat room connected to the first chat room and the third chat room independent of the first chat room. For example, the server may generate the second response message 1322 based on at least one message transmitted via the first chat room and at least one message transmitted via the third chat room that the user account has joined. The second chat room may be a personal mate chat room, and a message of the server, to be transmitted via the second chat room, may be a message of the personal mate.

Consequently, as described above with reference to FIGS. 2 to 6, the server may use chat data (e.g., long-term memory data) collected with respect to the user account in addition to the message transmitted via the first chat room to generate the second response message 1322. In the embodiments of the present disclosure, since the chat data collected with respect to the user account is collected based on messages transmitted via other chat rooms (e.g., the second chat room or the third chat room) that the user account has joined, generating a message based on the chat data collected with respect to the user account may be interpreted substantially in the same meaning as generating a message based on the messages transmitted via other chat rooms (e.g., the second chat room or the third chat room).

According to an embodiment, when generating the second response message 1322 to be transmitted via the second chat room, the server may preferentially consider message chunks transmitted via the first chat room rather than message chunks transmitted via other chat rooms. As described above with reference to FIGS. 4 to 6, the server may store information about message chunks (or threads) collected for each chat room that the user account has joined, as chat data (e.g., short-term memory data) on the chat room.

The server may determine a target message chunk associated with the query message from the message chunks transmitted via the first chat room. The server may determine the target message chunk based on a similarity (e.g., a cosine similarity) between information (e.g., a vector of the second query message 1321) about the second query message 1321 and information about each message chunk (e.g., a vector of each message chunk). The vector of the second query message 1321 or the vector of the message chunk may be obtained using a vector extraction model (e.g., the topic extraction model of FIG. 4).

The server may determine whether to generate the second response message 1322 based on the message chunk transmitted via the other chat room (e.g., the third chat room) based on whether the number of target message chunks determined from the message chunks transmitted via the first chat room is greater than or equal to a threshold number.

For example, the server may generate the second response message 1322 based on at least one message chunk transmitted via the third chat room based on that the number of target message chunks associated with the query message among the message chunks transmitted via the first chat room is less than the threshold number.

For example, the server may exclude the message chunk transmitted via the third chat room from generating the second response message 1322 based on that the number of target message chunks associated with the query message among the message chunks transmitted via the first chat room is greater than or equal to the threshold number. The server may generate the second response message 1322 based on the target message chunk associated with the query message among the message chunks transmitted via the first chat room.

According to an embodiment, when generating the second response message 1322, the server may determine whether to use messages (e.g., the original messages) included in the target message chunk or a summary of the target message chunk, based on whether the query message requests to search for a message transmitted via a chat room (e.g., the first chat room, the second chat room, or the third chat room).

For example, the server may determine the target message chunk associated with the query message among the message chunks transmitted via at least one chat room (e.g., the first chat room, the second chat room, or the third chat room). The server may determine whether the second query message 1321 requests to search for the message transmitted via at least one chat room. The server may generate the second response message 1322 based on the result of applying the response generation model to the messages (e.g., the original messages) included in a chunk of the target message, based on that the query message requests to search for the message transmitted via at least one chat room. The server may generate the second response message 1322 based on the result of applying the response generation model to the summary (e.g., summary text) of the target message chunk based on that the second query message 1321 does not request to search for the message transmitted via at least one chat room.

The server architecture according to the present disclosure includes a topic extraction engine and a memory management module that collectively optimize the retrieval and summarization of conversation data. By maintaining indexed short-term and long-term memory structures, the system avoids repetitive data queries, reduces inter-server communication overhead, and enhances response generation latency. These operations are performed automatically through trained machine learning models executed by the server's processing circuitry, thereby constituting an improvement to the efficiency and reliability of network-based messaging systems.

FIG. 13 mainly describes that when the server generates the second response message 1322, the server determines whether to apply the response generation model to the messages included in the target message chunk or apply the response generation model to the summary of the target message chunk based on whether the query message requests to search for the message transmitted via the first chat room, but is not limited thereto. For example, when generating the first response message, the server may determine whether to apply the response generation model to the messages included in the target message chunk or apply the response generation model to the summary of the target message chunk based on whether the query message requests to search for the message transmitted via the first chat room.

The server may transmit information to display the second response message 1322 on the second chat room screen to the user terminal. The user terminal may receive the second response message (or the information to display the second response message 1322). The user terminal may display the second response message 1322 on the second chat room screen based on receiving the second response message 1322 from the server.

The server may not provide information about the message transmitted via the second chat room including the second message 1321 and the second response message 1322 to the other user account. Consequently, the message transmitted via the second chat room may not be provided to the other user account joining the first chat room. The second query message 1321 and the second response message 1322 may be respectively referred to as a “private query message” and a “private response message” since the second query message 1321 and the second response message 1322 are not disclosed to the other user account.

In FIG. 13, in the embodiments of the present disclosure, it is mainly described that the server generates a response message to a query message obtained via the second chat room, but is not limited thereto. According to an embodiment, the user terminal may generate a response message to a query message input via the second chat room. For example, the user terminal may obtain a query message input via the second chat room. The user terminal may obtain (e.g., generate) a response message based on at least one message transmitted via the first chat room. The user terminal may display the response message via the second chat room based on obtaining the response message.

FIG. 14 illustrates an example of a hardware configuration of a system for a messaging service according to an embodiment.

Referring to FIG. 14, a system (e.g., the messaging system 100 of FIG. 1) for a messaging system according to an embodiment may include a user terminal 1410 (e.g., the user terminal 110 of FIG. 1) connected via a network 1430 (e.g., the network 130 of FIG. 1), and a server 1420 (e.g., the server 120 of FIG. 1).

The user terminal 1410 according to an embodiment may be a mobile terminal implemented as a computer device. For example, the user terminal 1410 may communicate with the server 1420 and/or other electronic devices (e.g., other user terminals or other servers) via the network 1430 using a wireless communication scheme and/or a wired communication scheme.

The server 1420 according to an embodiment may be implemented as a computer device or a plurality of computer devices providing an instruction, code, a file, content, or a service by communicating with the user terminal 1410 and/or other servers via the network 1430. The communication scheme is not limited and may include a communication scheme using a communication network (e.g., a mobile network, wired Internet, wireless Internet, or a broadcasting network) included in the network 1430 and NFC among devices. For example, the network 1430 may include at least one of a personal area network (PAN), a local area network (LAN), a campus area network (CAN), a metropolitan area network (MAN), a wide area network (WAN), a broadband network (BBN), and the Internet.

According to an embodiment, the server 1420 may provide a file to install an app in the user terminal 1410 connected via the network 1430. In this case, the user terminal 1410 may install an app (e.g., an app associated with an IMS) using the file provided by the server 1420. In addition, the user terminal 1410 may receive a service or content provided by the server 1420 by connecting to the server 1420 under the control of an operating system (OS) or at least one program (e.g., a browser or an installed app). For example, when the user terminal 1410 transmits a request related to a service to the server 1420 via the network 1430 under the control of the app, the server 1420 may transmit code corresponding to the request to the user terminal 1410, and the user terminal 1410 may provide the content to the user by configuring and displaying a screen in response to the code according to the control of the app.

According to an embodiment, the user terminal 1410 may include a memory 1411, a processor 1413, a communication module 1415, and an input/output (I/O) interface 1417. The server 1420 may include a memory 1421, a processor 1423, a communication module 1425, and an I/O interface 1427.

The processors 1413 and 1423 according to an embodiment may perform at least one operation related to the messaging service described above with reference to FIGS. 1 to 13. For example, the processor 1413 may perform at least one operation of the user terminal 1410, performed by an app or web related to the messaging service described above with reference to FIGS. 1 to 13, and the processor 1423 may perform at least one operation of the server 1420 that provides the messaging service described above with reference to FIGS. 1 to 13. The processors 1413 and 1423 may be configured to process an instruction of a computer program by performing basic arithmetic, logic, and I/O operations. The instruction may be provided to the processors 1413 and 1423 by the memories 1411 and 1421 or the communication modules 1415 and 1425. The processors 1413 and 1423 may include processing circuitry. The instruction, when executed by the processors 1413 and 1423, may cause a device (e.g., the user terminal 1410 and the server 1420) to perform an operation instructed by the instruction.

The memories 1411 and 1421 may be computer-readable storage media and may be volatile or non-volatile memories. The memories 1411 and 1421 according to an embodiment may store information to run an app or web related to the messaging service described above with reference to FIGS. 1 to 13.

The memory 1411 according to an embodiment may include code for an app related to a messaging service installed and run on the user terminal 1410 by files provided by the server 1420 via the network 1430.

The memory 1421 according to an embodiment may store a program in which operations for the messaging service described above with reference to FIGS. 1 to 13 are implemented.

The communication modules 1415 and 1425 according to an embodiment may include communication circuitry. The communication modules 1415 and 1425 may provide a function for the user terminal 1410 and the server 1420 to communicate with each other via the network 1430 and may provide a function to communicate with other electronic devices or other servers.

For example, a request generated by the processor 1413 of the user terminal 1410 according to program code related to an app associated with the messaging service stored in a storage medium, such as the memory 1411, may be transmitted to the server 1420 via the network 1430 under the control of the communication module 1415.

For example, a control signal, an instruction, content, or a file provided under the control of the processor 1423 of the server 1420 may be transmitted to the user terminal 1410 via the communication module 1415 of the user terminal 1410 via the communication module 1425 and the network 1430.

The I/O interfaces 1417 and 1427 may be a means for interfacing with an I/O device 1419. For example, an input device may include a device, such as a keyboard or a mouse, and an output device may include a device, such as a display for displaying a communication session of an app. In another example, the I/O interface 1417 may be a means for interfacing with a device in which input and output functions are integrated, such as a touchscreen. As a more specific example, to process an instruction of a computer program loaded to the memory 1411, the processor 1413 of the user terminal 1410 may display a service screen or content configured using the data provided by the server 1420 on a display via the I/O interface 1417. For example, at least one interface screen described above with reference to FIGS. 1 to 13 may be displayed on the display via the I/O interface 1417. An input received from a user via the I/O device 1419 may be provided in a form that may be processed by the processor 1413 of the user terminal 1410 via the I/O interface 1417.

According to an embodiment, the user terminal 1410 and the server 1420 may include other components that are not shown in FIG. 14. For example, the user terminal 1410 may be implemented to include at least a portion of the I/O device 1419 described above or may further include other components, such as a transceiver, a global positioning system (GPS) module, a camera, a sensor, or a database.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

### Technical Improvement

The described processes result in reduced message retrieval latency, optimized storage efficiency, and enhanced contextual accuracy during response generation.

The claimed subject matter is not directed to an abstract idea of “communication between users” or “providing a virtual assistant.” Instead, it is directed to specific improvements in the functioning of computer systems and messaging platforms, including:
(1) A dual-layer user interface and data architecture that enables concurrent, context-linked chat sessions between human users and a virtual object without disrupting ongoing network communication threads;
(2) A dynamic message management mechanism that automatically structures multi-room conversations into semantically coherent “threads” and “message chunks” through topic extraction and action identification models;
(3) A hierarchical memory management system (short-term vs. long-term data) that improves message retrieval, reduces redundant data transmission, and optimizes system resource use during context-based response generation; and
(4) A technical process for generating contextually relevant responses using distributed data from multiple chat rooms, subject to real-time thresholding and chunk prioritization, thus improving server-side processing efficiency and user-terminal responsiveness.

These features collectively improve the operation of the computer itself—by reducing latency, improving contextual response generation accuracy, minimizing network and memory loads, and enabling new functionality not possible in conventional instant messaging systems.

The embodiments disclosed herein are implemented using specific improvements to computer functionality. The described architectures, data structures, and processing sequences enable a computer system to perform tasks that could not be executed using conventional instant messaging systems, including concurrent virtual and human chat session management, contextual message retrieval across distributed data sources, and adaptive response generation based on hierarchical memory data. These improvements are rooted in computer technology and provide a practical application that meaningfully limits any abstract concept to a specific technological implementation.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a server that provides an instant messaging service (IMS), the method comprising:
transmitting, to a user terminal using the IMS with a user account, information to display a first chat room screen corresponding to a first chat room in which the user account and another user account participate;
receiving a first query message input via the first chat room screen;
transmitting information to display the first query message to another user terminal using the IMS with the other user account;
generating a first response message to the first query message;
transmitting the first response message via the first chat room to the user terminal and the other user terminal;
when receiving a second query message input via a second chat room between the user account and a virtual subject assigned to the user account, generating a second response message based on at least one message transmitted via the first chat room; and
transmitting the second response message via the second chat room.

2. The method of claim 1, further comprising:
transmitting, to the user terminal, information for the user terminal to generate a layer to display an overlay on the first chat room screen and render a screen corresponding to the second chat room on the layer.

3. The method of claim 1, wherein information about a message transmitted via the second chat room including the second query message and the second response message is not provided to the other user account.

4. The method of claim 1, wherein the generating of the second response message comprises generating the second response message based on at least one message transmitted via the first chat room and at least one message transmitted via a third chat room in which the user account participates, and
the third chat room is independent of the first chat room.

5. The method of claim 4, wherein the generating of the second response message further comprises, based on that a number of target message chunks associated with the second query message among message chunks transmitted via the first chat room is less than a threshold number, generating the second response message based on at least one message chunk transmitted via the third chat room.

6. The method of claim 4, wherein the generating of the second response message further comprises, based on that a number of target message chunks associated with the second query message among message chunks transmitted via the first chat room is greater than or equal to a threshold number, excluding a message chunk transmitted via the third chat room from generating the second response message.

7. The method of claim 4, wherein the generating of the second response message comprises:
determining a target message chunk associated with the second query message among message chunks transmitted via the first chat room;
based on that the second query message requests to search for a message transmitted via at least one chat room, generating the second response message based on messages included in the target message chunk; and
based on that the second query message does not request to search for the message transmitted via the at least one chat room, generating the second response message based on a summary of the target message chunk.

8. The method of claim 1, wherein the generating of the first response message comprises excluding a message transmitted via a chat room other than the first chat room from generating the first response message.

9. The method of claim 1, further comprising:
receiving a recommendation request to recommend an account to be invited to a chat room from the user terminal;
among friend accounts registered as friends in the user account, determining at least one of an account that uses a terminal positioned near the user terminal, an account that uses a terminal obtaining a motion input that is the same as or similar to a motion input obtained from the user terminal, or an account determined from the friend accounts based on text describing the chat room, to be a recommended account; and
transmitting, to the user terminal, information to display information about the determined recommended account.

10. The method of claim 1, further comprising:
receiving user information from the user terminal;
generating a profile of a virtual character of the user account based on the user information;
transmitting information to display information about the profile of the virtual character to the user terminal; and
transmitting information to display the second chat room as a chat room in which the user account and the virtual character participate.

11. The method of claim 10, further comprising:
receiving, from the other user terminal using the IMS with the other user account, a content transmission request to transmit content to the user account from the other user account via the virtual character; and
transmitting, to the user terminal, information to output the content corresponding to the content transmission request via the virtual character in a profile of the user account.

12. The method of claim 1, wherein the generating of the second response message comprises transmitting information to display a screen corresponding to the second chat room to the user terminal based on a user input to invoke the second chat room, and
the user input is obtained from the first chat room screen.

13. A method performed by a user terminal using an instant messaging service (IMS) with a user account, the method comprising:
displaying a first chat room screen corresponding to a first chat room in which the user account and another user account join;
obtaining a first query message input via the first chat room screen;
displaying a first response message to the first query message on the first chat room screen;
on the first chat room screen, displaying a screen corresponding to a second chat room between the user account and a virtual subject assigned to the user account;
obtaining a second query message input via the second chat room; and
based on obtaining a second response message generated based on at least one message transmitted via the first chat room, displaying the second response message via the second chat room,
wherein a message transmitted via the first chat room including the first query message and the first response message is provided to the other user account.

14. The method of claim 13, wherein the displaying of the screen corresponding to the second chat room comprises:
generating a layer to display an overlay on the first chat room screen; and
rendering the screen corresponding to the second chat room on the generated layer.

15. The method of claim 13, wherein a message transmitted via the second chat room including the second query message and the second response message is not provided to the other user account.

16. The method of claim 13, wherein the second response message is generated based on at least one message transmitted via the first chat room and at least one message transmitted via a third chat room in which the user account joins, and
the third chat room is independent of the first chat room.

17. The method of claim 16, wherein the second response message is generated based on at least one message chunk transmitted via the third chat room based on that a number of target message chunks associated with the second query message among message chunks transmitted via the first chat room is less than a threshold number.

18. A non-transitory computer-readable storage medium storing instructions that, when executed by a processor, cause the processor to perform the method of claim 1.

19. A server comprising:
at least one processor including processing circuitry; and
a memory storing instructions,
wherein the instructions, when executed by the at least one processor, cause the server to:
transmit, to a user terminal using an instant messaging service (IMS) with a user account, information to display a first chat room screen corresponding to a first chat room in which the user account and another user account join,
receive a first query message input via the first chat room screen,
transmit information to display the first query message to another user terminal using the IMS with the other user account,
generate a first response message to the first query message,
transmit the first response message via the first chat room to the user terminal and the other user terminal,
when receiving a second query message input via a second chat room between the user account and a virtual subject assigned to the user account, generate a second response message based on at least one message transmitted via the first chat room, and
transmit the second response message via the second chat room.
